(19) United States
(12) Patent Application Publication
(10) Pub. No.: US 2024/0346825 A1
(43) Pub. Date: Oct. 17, 2024

(54) SYSTEMS AND METHODS FOR MONITORING EMISSION INDICATORS

(71) Applicant: ExxonMobil Technology and Engineering Company, Spring, TX (US)

(72) Inventors: Di DU, Basking Ridge, NJ (US); Christopher G. GURCIULLO, Bangor, PA (US); Venkatesh MEENAKSHISUNDARAM, Westfield, NJ (US); David R. SHAY, Cypress, TX (US)

(73) Assignee: ExxonMobil Technology and Engineering Company, Spring, TX (US)

(21) Appl. No.: 18/630,790

(22) Filed: Apr. 9, 2024

Related U.S. Application Data
(60) Provisional application No. 63/496,246, filed on Apr. 14, 2023.

(51) Int. Cl. G06V 20/50; F23G 7/08; G06V 10/26; G06V 10/82; G06V 10/94

(52) U.S. Cl. CPC G06V 20/50; G06V 10/26; G06V 10/82; G06V 10/95; F23G 7/085

(57) ABSTRACT

Some examples include systems and methods for monitoring emission indications. A system has an image sensor to capture an image of a flare stack. A computer vision engine is configured to determine whether an emission indicator captured by the image indicates an emission event. A server engine is configured to transmit a notification indicating whether the emission indicator indicates the emission event to a control system of the flare stack. The computer vision engine is configured to update one or more model settings, one or more thresholds, or a combination thereof based on one or more settings. In one embodiment, the computer vision engine is configured to identify, using a deep convolutional neural network (DCNN) model, the emission indicator captured by the image.

### TECHNICAL FIELD

The technical field relates to emissions monitoring, and in particular to systems and methods for monitoring emission indicators.

### BACKGROUND

Flare stacks, which are gas combustion devices, may emit gaseous discharges or produce flames during controlled burn processes. A controlled burn process may be used for stabilizing pressure and flow of gases from a well, for safely disposing waste or other unwanted gases at industrial sites, or for safely releasing pressure at industrial sites during a safety or emergency situation, for instance. The waste or unwanted gases may be by-products produced during petroleum processing at a refinery, chemical or petrochemical plant, natural-gas processing plant, offshore exploration platform, or land well, for instance. Flare stacks may be used at power plants, paper and pulp plants, or landfills as well. Flare stacks are monitored in accordance with governmental regulations. The governmental regulations may prescribe limits on how much unburned hydrocarbon may be released into the atmosphere from the flare stack during a time period. Monitoring may include periodic visual inspection by plant personnel.

### BRIEF SUMMARY

This disclosure relates to systems and methods for monitoring emission indicators. In particular, the presently disclosed subject matter relates to a system and method for monitoring emission indicators used by a control system of the flare stack.

The present disclosure includes an electronic device that includes a processor, and a non-transitory computer-readable medium storing machine-readable instructions, which, when executed by the processor, cause the processor to identify, using a computer vision model, an emission indicator captured by an image; determine, using the computer vision model, one or more parameters of the emission indicator; and generate an indication indicating whether the emission indicator is representative of a emission event based on the one or more parameters.

The present disclosure also includes a method that includes identifying, using a computer vision model, an emission indicator captured by an image; determining, using the computer vision model, one or more parameters of the emission indicator; and generating an indication indicating whether the emission indicator is representative of a emission event based on the one or more parameters.

The present disclosure also includes a system that includes an image sensor to capture an image of a flare stack; one or more non-transitory, computer-readable mediums storing a computer vision engine configured to determine whether an emission indicator captured by the image indicates an emission event; and a server engine configured to transmit a notification indicating whether the emission indicator indicates the emission event to a control system of the flare stack.

These and other features and attributes of the systems and methods for monitoring emission indicators of the present disclosure and their advantageous applications and/or uses will be apparent from the detailed description which follows.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a system for monitoring emission indicators, in accordance with certain embodiments.

FIG. 2 is a method for monitoring emission indicators, in accordance with certain embodiments.

FIG. 3 is an image used for monitoring emission indicators, in accordance with certain embodiments.

FIG. 4 is to an output of a system or method for monitoring emission indicators, in accordance with certain embodiments.

FIGS. 5A-5E are images used for testing a model used for monitoring emission indicators, in accordance with certain embodiments.

FIG. 6 is an output illustrating a correlation between density and opacity parameters, in accordance with certain embodiments.

FIGS. 7A-7B are plots illustrating respective brightness and sharpness indexes using in training a model, in accordance with certain embodiments.

FIGS. 7C-7D are images used for monitoring emission indicators, in accordance with certain embodiments.

### DETAILED DESCRIPTION

This application relates to systems and methods for monitoring emission indicators. In particular, the presently disclosed subject matter relates to a system and method for monitoring emission indicators used by a control system of a flare stack.

As described above, flare stack emissions are a government-regulated, controlled process for safely disposing unwanted by-products within prescribed limits. Monitoring performed in accordance with government regulations may include periodic visual inspection by plant personnel to determine whether hydrocarbon is emitted into the atmosphere. Facilities may have multiple flare stacks distributed in such a way as to necessitate either multiple plant personnel, each visually inspecting a different subset of the flare stacks, an individual dividing attention between multiple flare stacks, or a combination thereof. Therefore, visual inspection may be inefficient in respect to both time and cost of personnel. Additionally, periodic inspections do not provide continual monitoring. Visual inspections are also subject to human error.

In contrast to prior approaches, using the systems, devices, or methods for monitoring emission indicators described herein enables continual monitoring of emissions of one or more flare stacks, in both a time- and cost-effective manner. Additionally, the systems, devices, or methods for monitoring emission indicators described herein are more accurate than visual inspection by a person.

### Terminology

An emission indicator, as used herein, is a visible sign captured by an image of a flare stack that a by-product is being emitted from the flare stack. The visible sign may include a gaseous cloud, water vapor, steam, smoke, flame, fine particulates, pilot light presence, or a combination thereof.

### System

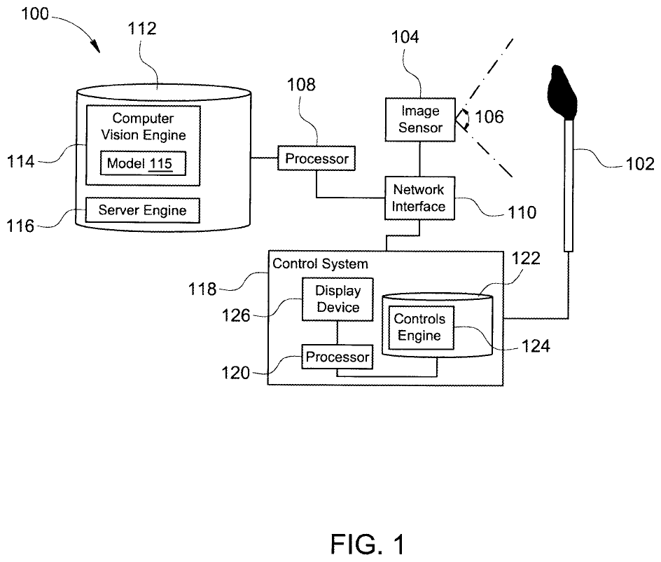

FIG. 1 is a non-limiting example of a system 100 for monitoring emission indicators, in accordance with certain embodiments. System 100 includes a flare stack 102 within a field of view 106 of an image sensor 104. System 100 also includes a processor 108 communicatively coupled to a computer-readable medium 112. The computer-readable medium 112 stores machine-readable instructions, which when executed by the processor 108, cause the processor 108 to monitor emission indicators using one or more images of the flare stack 102 captured by the image sensor 104. The machine-readable instructions may be machine-readable instructions of a computer vision engine 114, a server engine 116, or a combination thereof, for example. The image sensor 104 may transmit the one or more images to the processor 108 via a network interface 110.

During the monitoring of emission indicators, the processor 108 may cause transmission of notifications to the control system 118 via the network interface 110. The notifications may include, but are not limited to, the one or more images of the flare stack 102 captured by the image sensor 104, one or more videos of one or more emission events, one or more graphs including information associated with the one or more emission events, one or more instructions, or the like. The one or more graphs may include one or more parameters (e.g., area, density, volume, period, color) associated with an emission event, for example.

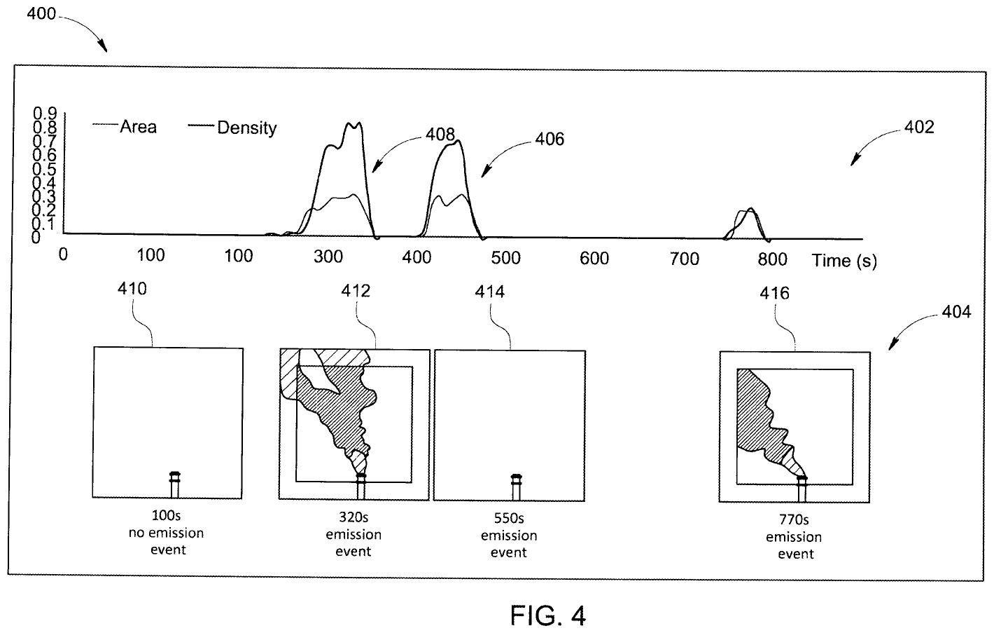

The control system 118 is a system for controlling emissions of the flare stack 102. In response to a notification, the control system 118 may perform one or more actions described herein. For example, the control system 118 may display via a display device 126 the one or more images of the flare stack 102 received from the image sensor 104 via the network interface 110 in conjunction with one or more graphs received from the processor 108 via the network interface 110. In another example, the control system 118 may display an output 400 shown in FIG. 4.

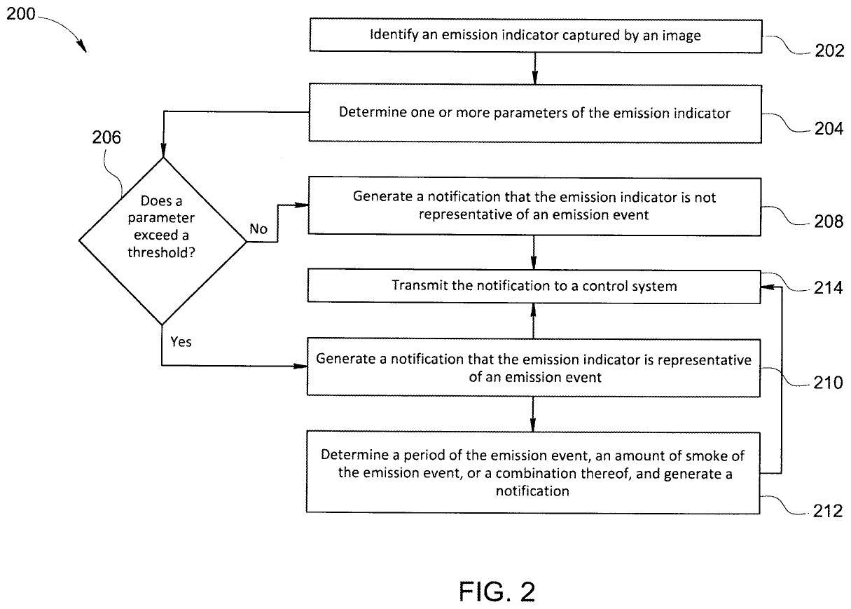

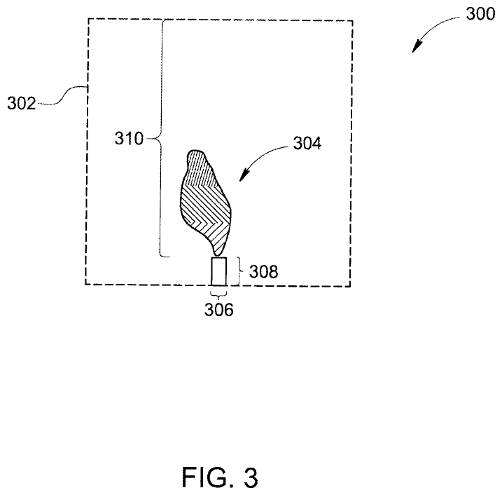

In a non-limiting example, the computer-readable medium 112 stores the computer vision engine 114 and the server engine 116. The computer vision engine 114 determines whether an emission indicator captured by an image of the flare stack 102 indicates an emission event. The image of the flare stack 102 may be an image 300 shown in FIG. 3, for example. To determine whether the emission indicator indicates the emission event, the computer vision engine 114 performs, at least in part, the method 200 of FIG. 2, for example. The server engine 116 transmits a notification indicating whether the emission indicator indicates the emission event to the control system 118 of the flare stack 102. In a non-limiting example, the server engine 116 is an application programming interface (API) server that enables other software programs (e.g., computer applications, computer programs) to communicate with the computer vision engine 114.

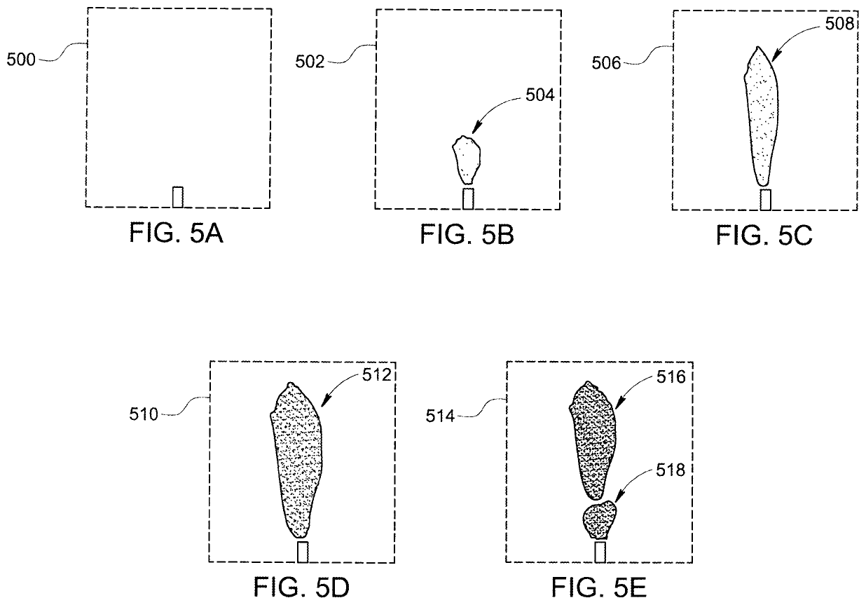

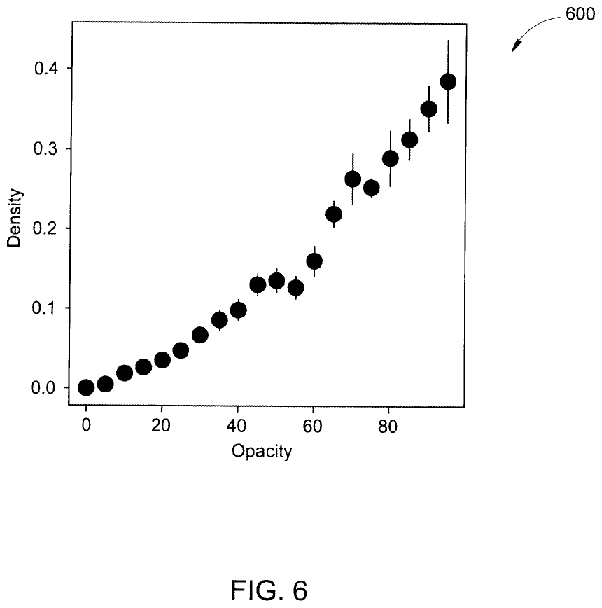

In a non-limiting example, to determine whether the emission indicator captured by the image of the flare stack 102 indicates the emission event, the computer vision engine 114 includes a model 115. The model 115 is a deep convolutional neural network (DCNN), for example. The model 115 may be trained using techniques described with respect to FIGS. 5A-5E, 6, or 7A-7D, for example. The computer vision engine 114 segments a region of the image including the emission indicator using the model 115. The computer visions engine 114 calculates one or more parameters for the region using the model 115. The one or more parameters may include a density of the emission event, an area of the image including the emission event, a volume of the emission event, a period of the emission event, a color of the emission event, or a combination thereof. In response to the one or more parameters exceeding one or more associated thresholds (e.g., density >=density threshold, area >=area threshold, volume >=volume threshold, period >=period threshold, color >=color threshold), the computer vision engine 114 determines that the emission indicator indicates the emission event. In response to the one or more parameters being less than the one or more thresholds (e.g., density <density threshold, area <area threshold, volume <volume threshold, period <period threshold, color <color threshold), the computer vision engine 114 determines that the emission indicator indicates another event. The another event may include a transitory object (e.g., balloon, flock of birds) captured by the image sensor, for example.

While in the preceding example, exceeding indicates a first value is equivalent to or greater than a second value, equivalence may be specified by a manufacturer of the computer vision engine 114, a user of the system 100, or a combination thereof. For example, a user of the system 100, may adjust one or more settings of the model 115 to indicate that exceeding indicates the first value is greater than the second value and less than indicates that the first value is equivalent to or less than the second value. Inclusion of equivalence may be based on whether the threshold is inclusive of a maximum value indicated by a tolerance range, for example. In a non-limiting example, the server engine 116 receives the one or more settings updates from the control system 118 via the network interface 110. For example, a user of the control system 118 may modify the one or more settings of the model 115 using an input device of the control system 118. The user of the control system 118 may modify the one or more settings 115 via a user interface (e.g., browser, software program) that enables access to the computer vision engine 114, for example. The computer vision engine 114 modifies the one or more settings of the model 115 based on the one or more settings updates. The one or more settings of the model 115 may include equivalence, one or more threshold values (e.g., density threshold, area threshold, volume threshold, period threshold, color threshold), tolerance ranges for the one or more threshold values (e.g., +/−1%, +/−2.5%, +/−5%), or other variables associated with the model 115.

In a non-limiting example, the computer vision engine 114 may determine a period of the emission event, a density of the emission event, an area of the image including the emission event, a volume of the emission event, a color of the emission event, or a combination thereof. For example, a first image of the one or more images of the flare stack 102 is associated with a first time stamp and a second image of the one or more images of the flare stack 102 is associated with a second time stamp. The computer vision engine 114 may determine that the emission indicator is absent from the second image and calculate a period of the emission event by subtracting the first time stamp from the second time stamp. In a non-limiting example, the computer vision engine 114 generates a video of the emission event using the first image, the second image, and images between the first and second images. In another example, the computer vision engine 114 determines an amount of smoke of the emission event based on the period of the emission event and at least one of the density of the emission event, the area of the image including the emission event, the volume of the emission event, or the color of the emission event. The computer vision engine 114 may transmit the period of the emission event, the video of the emission event, the amount of smoke of the emission event, or the combination thereof, to the control system 118 via the server engine 116.

The control system 118 includes a processor 120 coupled to a computer-readable medium 122 storing machine-readable instructions, in a non-limiting example. The machine-readable instructions include a controls engine 124, for example. When executed by the processor 120, the machine-readable instructions stored to the computer-readable medium 122 cause the processor 120 to control operations of the flare stack 102, display via the display device 126 the one or more notifications generated by the computer vision engine 114, generate a report (e.g., an emissions report) including the one or more notifications generated by the computer vision engine 114, or a combination thereof, for example. The display device 126 may be a display, a monitor, a printer, a projector, or other like output device for displaying data. For the purpose of these simplified schematic illustrations and description, there may be additional equipment including, but not limited to pipes, valves, sensors, drums, headers, ignition devices, and the like that are customarily deployed in flare operations and that are well known to those of ordinary skill in the art which are not shown and/or not described in the present disclosure. Controlling operations of the flare stack 102 may include controlling one or more of the additional equipment, for example.

While the flare stack 102 illustrated in FIG. 1 is a single point burner, in other embodiments, the flare stack 102 may be a multipoint burner having several exit points. The flare stack 102 may be horizontal, elevated, or slanted, depending upon a type of the facility at which the flare stack 102 is located. The flare stack 102 may be an air-assisted flare, a pressure-assisted flare, or a steam-assisted flare. The flare stack 102 may be selected in accordance with a specified safety, environmental, and/or economic guideline, for example. While FIG. 1 illustrates a single flare stack 102, the system 100 may include multiple flare stacks. The multiple flare stacks may be within the field of view 106 of the image sensor 104, or the system 100 may include multiple image sensors and each field of view of an image sensor of the multiple image sensors may capture one or more flare stacks of the multiple flare stacks. The image sensor 104 may be a complementary metal-oxide-semiconductor (CMOS), a back-illuminated CMOS, a charge-coupled device (CCD), an electron-multiplying charge-coupled device (EMCCD), a time-of-flight (TOF) sensor, a photosensitive device of an analog camera, an Internet Protocol (IP) camera (e.g., a network camera), or another digital camera.

While FIG. 1 illustrates a single image sensor 104, the system 100 may include multiple image sensors. In a non-limiting example, a camera may include multiple image sensors. The multiple image sensors may each be a different type of image sensor. In another non-limiting example, the system 100 may include multiple cameras distributed so as to capture one or more flare stacks of multiple flare stacks, different angles of one or more flare stacks of the multiple flare stacks, or a combination thereof.

Additional description of system 100 including image sensor 104, network interface 110, the processor 108, and the computer-readable medium 112 in embodiments is further described below. Methods for monitoring emission indicators which can use, but are not limited system 100, are also provided.

### Method

FIG. 2 is a method 200 for monitoring emission indicators, in accordance with certain embodiments (steps 202-214, also referred to as blocks). The method 200 is a method performed by the system 100, for example. The method 200 includes identifying an emission indicator captured by an image (step 202), determining one or more parameters of the emission indicator (step 204), determining whether a parameter of the one or more parameters exceeds a threshold (step 206), generating a notification that the emission indicator is not representative of an emission event (step 208) in response to a determination that the parameter does not exceed the threshold, generating a notification that the emission indicator is representative of an emission event (step 210) in response to a determination that the parameter exceeds the threshold, determining a period of the emission event, an amount of smoke of the emission event, or a combination thereof and generating a notification (step 212), and transmitting the notification to a control system (step 214).

In a non-limiting example, the method 200, prior to step 202, first receives data. The data may be an indicator to start the method 200, such as an indicator generated when a user causes a software program for monitoring emission indicators to execute, for example. In another example, the data may be one or more images captured by one or more image sensors (e.g., image sensor 104 described in FIG. 1). Each image of the one or more images may be a picture, a frame from a video, or the like. The one or more images are images of a flare stack (e.g., flare stack 102 described in FIG. 1). Receiving the data includes capturing the one or more images, such as when an IP camera includes an image sensor, a network interface, a processor, and a computer-readable medium storing a computer vision engine (e.g., computer vision engine 114 described in FIG. 1), for example. In another example, receiving the data includes receiving the data via a network interface (e.g., network interface 110 described in FIG. 1), such as when the image sensor is an analog camera coupled to an IP encoder. In yet another example, receiving the data includes retrieving the data from a computer-readable medium (e.g., the computer readable medium 112, 122 described in FIG. 1), such as when multiple images of one or more flare stacks are captured by multiple image sensors. Time stamps of the multiple images may be correlated. Correlated images having a same time stamp may be aggregated and stored to a computer-readable medium.

In a non-limiting example, the method 200 includes processing the one or more images. Processing the one or more images may include cropping the one or more images, resizing the one or more images, enhancing the one or more images, or other processing techniques that generate an image consistent with a specification. For example, in response to the specification indicating that images used for training a model had a resolution of 256×256 with flare tips approximately centered in the images and having widths between 6 to twenty-four (24) pixels, the method 200 includes processing the one or more images such that post-processing, each image of the one or more images has a resolution of 256×256 and a flare tip approximately centered in the image and having a width of 6 to 24 pixels. The method 200 includes cropping the one or more images so that each image includes a single flare stack. An image including multiple flare stacks may be cropped multiple times, such that each cropping generates another image with a single flare stack of the multiple flare stacks within the another image. For example, the method 200 includes cropping an image including two flare stacks twice to generate two images, where a first instance of cropping the image generates a first image having a first flare stack centered within the first image and a second instance of cropping the image generates a second image having a second flare stack centered within the second image. The method 200 may include one or more of resizing or enhancing the first image, the second image, or a combination thereof, to have a specified resolution.

In a non-limiting example, the method 200 includes using one or more models (e.g., model 115 described in FIG. 1) to identify an emission indicator captured by an image (step 202). The method 200 includes segmenting an image using the one or more models to generate a binary, or Boolcan, matrix (e.g., values are 0s or 1s). Dimensions of the binary matrix are equivalent to a resolution in pixels of the image, for example. In a non-limiting example, the method 200 includes determining that matrix entries, or elements, having a value of 1 indicate that an associated pixel includes an emission indicator (e.g., a matrix element at (1, 1) indicates that a pixel in a position (1, 1) of the image includes the emission indicator). In a non-limiting example, the method 200 also includes determining a number of contiguous elements having a value of 1. Contiguous, as used herein, indicates two elements are neighbors, e.g., sequential or share a border, (e.g., a matrix entry at (1, 2) is contiguous with matrix elements at (1, 1), (1, 3), (2, 1), (2, 2), (2, 3), a matrix element at (2, 2) is contiguous with matrix elements at (1, 1), (1, 2), (1, 3), (2, 1), (2, 3), (3, 1), (3, 2), (3, 3)). A set of emission indicators, as used herein, collectively refers to the contiguous elements having a value of 1.

In response to a determination that a size of a set of emission indicators exceeds a specified threshold, the method 200 includes determining that the set of emission indicators indicates an emission event (e.g., an output of step 206). In a non-limiting example, based on a number of elements, or pixels, separating one set of emission indicators from another set of emission indicators, the method 200 includes determining that the image includes multiple emission events, where each emission event is associated with a different set of emission indicators. The multiple emission events may be from different flare stacks, for example. In response to a determination that the size of the set of emission indicators does not exceed the specified threshold, the method 200 includes determining that the set of emission indicators does not indicate an emission event (e.g., an output of step 206). In a non-limiting example, the method 200 includes determining that the size of the set of emission indicators not exceeding the specified threshold indicates an artifact captured by the image or another event (e.g., an output of step 206).

In a non-limiting example, the method 200 includes determining one or more parameters of an emission event (e.g., step 212). The method 200 may include determining an area of the emission event, for example. The method 200 may include determining the area of the emission event is the size of a set of emission indicators associated with the emission event divided by a total number of pixels of the image, for example. In response to the image including multiple sets of emission indicators associated with the emission event, the method 200 may include determining the area of the emission event is a sum of the sizes of each set of emission indicators associated with the emission event divided by a total number of pixels of the image.

In a non-limiting example, the method 200 includes using the one or more models to determine a density of the emission event. The one or more models may determine one or more of an average color or a dominant color. For example, the method 200 includes using the one or more models to segment the emission event into a flame area and a smoke area and to segment a background area surrounding the smoke area. The background area may include a number of contiguous pixels to the smoke area. The background area may include pixels that are within 8 pixels of the smoke area, for example. The method 200 includes using the one or more models to determine an average red/green/blue (RGB) vector for the smoke area and for the background area. The method 200 includes subtracting a normalized projection of the average RGB vector for the smoke area to the background area from 1 to determine a density of the smoke area. In a non-limiting example, the density of the emission event is equivalent to the density of the smoke area.

In a non-limiting example, the method 200 may include determining a period of the emission event. The method 200 may include determining the period of the emission event using techniques described with respect to FIG. 1, for example. In another example, the method 200 may determine a each image of the one or more images of a flare stack are associated with a different time stamp (e.g., a first image has a first time stamp, a second image has a second time stamp, an nth image has an nth time stamp). The method 200 may include starting a first timer in response to a determination that a first image includes an emission event. The method 200 may include starting a second timer in response to a determination that a second image that is subsequent to the first image does not include an emission event. In response to a determination that subsequent images to the second image do not include emission events and that the second timer exceeding a time threshold, the method 200 includes determining the period of the emission event by subtracting the second timer from the first timer. In another example, the method 200 may include starting a counter in response to a determination that a subsequent image to the first image does not include an emission event. In response to a determination that further subsequent images do not include emission events and that the counter exceeding a counter threshold, the method 200 includes determining the period of the emission event by subtracting a time stamp of the first image from the time stamp of the subsequent image, where the counter is used to determine which image is the subsequent image (e.g., to determine the subsequent image number, the counter is subtracted from an image number when the counter exceeds the counter threshold).

In a non-limiting example, the method 200 includes determining a volume of the emission event. The method 200 may include determining the volume of the emission event using the sizes of different sets of emission indicators associated with the emission event from images of a flare stack captured by multiple image sensors from different angles, for example.

The method 200 may also include generating a notification that includes an indication of whether the image includes one or more emission events, one or more parameters of each emission event, one or more instructions associated with one or more emission events, or a combination thereof. The indication may include, but is not limited to, the image including one or more indicators (e.g., pointer, label, outline) notating each emission event, a video of each emission event, text including one or more parameters of each emission event (e.g., area, density, period, volume), text including an instruction, or a combination thereof. In a non-limiting example, the instruction includes an instruction to inject steam into a flare stack. Injecting steam is an example of a range of responses that may include performing no action, modifying one or more flow rates (e.g., combustion gas, flare gas), modifying one or more pilot lights or igniters. In a non-limiting example, the method 200 includes storing the notification that includes an indication of whether the image includes one or more emission events, one or more parameters of each emission event, one or more instructions associated with one or more emission events, or a combination thereof, to a computer-readable medium (e.g., the computer-readable medium 112 described by FIG. 1). The method 200 includes transmitting the notification to a control system (e.g., control system 118 described in FIG. 1). The method 200 may also include the control system displaying the notification, storing the notification to a computer-readable medium (e.g., the computer-readable medium 122 described in FIG. 1), or a combination thereof.

The steps of the method 200 may be executed by one or multiple computer applications. The steps of the method 200 may be executed in any order, and in any combination, except where logic dictates otherwise, and may individually be executed one or more times. As a non-limiting example, step 202 may be executed six (6) times followed by one (1) execution of block 204, followed by executions of block 206 three (3) times then executions of block 208 two (2) times, block 210 one (1) time, and block 214 one (1) time. Executing a block multiple times may ensure an accuracy of data, a repeatability of a determination, or a combination thereof, thereby increasing an accuracy and reliability of outputs of the method 200.

### Flare Stack Image Example

FIG. 3 is an image 300 used for monitoring emission indicators, in accordance with certain embodiments. The image 300 is an image of a flare stack (e.g., flare stack 102 described in FIG. 1) within a field of view (e.g., field of view 106 described in FIG. 1) of an image sensor (e.g., image sensor 104 described in FIG. 1). The image 300 may be processed to generate an image consistent with a specification. The image 300 may be processed using techniques described with respect to FIG. 2, for example. In a non-limiting example, in response to the specification specifying a resolution for the image 300, a system (e.g., the system 100) or method (e.g., the method 200) for monitoring emission indicators may crop the image 300 to dimensions consistent with the specification as indicated by the box 302. The system, device, or method for monitoring emission indicators may adjust the image 300 so that a flare tip of the flare stack is approximately centered in the box 302. In a non-limiting example, the specification may also specify a range in pixels for a width 306 of the flare tip, a range in pixels for a height 308 of the flare tip, a minimum height 310 for a region of interest (ROI), or a combination thereof. For example, the specification may specify that the range in pixels for the width 306 of the flare tip is between 6 and twenty-four (24) pixels, the minimum height 310 of the ROI is at least twenty (20) times the width 306 of the flare tip, and the height 308 of the flare tip is approximately 10% of the minimum height 310 of the ROI. The system, device, or method for monitoring emission indicators may perform a combination of different processing techniques (e.g., cropping, resizing, enhancing, or the like) so that an image within the box 302 that is consistent with the specification.

### Example Emission Events

FIG. 4 is an output 400 of a system (e.g., system 100 described in FIG. 1) or method (e.g., method 200 described in FIG. 2) for monitoring emission indicators, in accordance with certain embodiments. The output 400 may be displayed on a display device (e.g., display device 126 described in FIG. 1), printed by a printer, stored to a computer-readable medium (e.g., computer-readable medium 122 described in FIG. 1), or a combination thereof, for example. The output 400 includes an area 402 displaying a graph and an area 404 displaying images 410, 412, 414, 416. In a non-limiting example, the images 410, 412, 414, 416 are each starting frames of a video. A user may select an image of the images 410, 412, 414, 416 to cause the video to play, for example. The graph of the area 402 includes a plot 406 showing changing areas of emission events associated with each of the images 410, 412, 414, 416 and a plot 408 showing changing densities of emission events associated with each of the images 410, 412, 414, 416. An x-axis of the plots 406, 408 indicate a time in seconds (sec), and a y-axis of the plots 406, 408 indicate a ratio of the area or density, respectively, with respect to a total area or opacity of the images 410, 412, 414, 416.

In a non-limiting example, the output 400 is a time series of a smoke area and density associated with four snapshots of a 14-minute video. The system, device, or method for monitoring emission indicators uses an area threshold of 1.3% and a density threshold of 2.3% as model settings to identify emission indicators, for example. During the 14-minutes of monitoring, the system, device, or method for monitoring emission indicators detects three emission events. The system, device, or method for monitoring emission indicators does not detect an emission events until approximately 220 sec. An image 410 shows no emission event is visible. The system, device, or method for monitoring emission indicators detects a first emission event that has a period of approximately 120 sec. An image 412 shows a peak of the first emission event at approximately 320 sec. The peak indicates that smoke of the emission event is approximately 0.29, or 29%, of the total area of the image 412 and that a density of the smoke reduces opacity of the image 412 by approximately 0.67, or 67%. The system, device, or method for monitoring emission indicators detects a second emission event at approximately 400 sec that has a period of approximately 70 sec and a similar area and density of smoke as the first emission event. An image 414 shows no emission event is visible for approximately 280 sec. The system or method for monitoring emission indicators detects a third emission event that has a period of approximately 40 sec. An image 416 shows a peak of the third emission event at approximately 770 sec. The peak indicates that smoke of the emission event is approximately 0.20, or 20%, of the total area of the image 412 and that a density of the smoke reduces opacity of the image 412 by approximately 0.22, or 22%. In a non-limiting example, the peak, the area, the period, the density, the opacity, or a combination thereof, of each emission event may be transmitted, stored, or a combination thereof, for inclusion in an emission report.

In a non-limiting example, the area 404 includes a live video feed of one or more flare stacks. In a non-limiting example, the area 402 may be overlaid on the area 404. The overlay may result in the graph displayed in the area 402 disposed atop a live video feed of the one or more flare stacks displayed in the area 404. Area 402 and area 404 may share borders, area 402 may be enclosed within area 404 (e.g., picture in picture), at least one border of the area 402 may overlap one or more borders of the area 404 (e.g., area 402 may be partially within area 404) or may share a border of the area 404 (e.g., area 402 and area 404 may be aligned vertically, as shown in FIG. 4, or may be aligned side by side), for example.

Since the systems and methods for monitoring emission indicators described herein do not alter data received from one or more image sensors, the systems and methods for monitoring emission indicators described herein do not interfere with existing recording policies or procedures at a facility. Additionally, because the systems and methods for monitoring emission indicators described herein may process the data as separate streams, the processed data may be displayed simultaneously with the original data by the control system. The processed data may also include notifications generated by the systems and methods for monitoring emission indicators. Presenting the processed data and the original data simultaneously enables a user or operator of the control system to continuously monitor one or more flare stacks of the facility. The processed data may also be stored and used for long-term monitoring of flare stack performance, reporting purposes, and as data to improve the model used by the systems and methods for monitoring emission indicators. For example, the processed data may be fed into a machine learning technique to determine one or more updated settings. The updated settings may be model settings, thresholds, or a combination thereof. The control system may transmit the one or more updated settings to the system for monitoring emission indicators. In a non-limiting example, the updated settings may be different for different systems for monitoring emission indicators.

FIGS. 5A-5E include images 500, 502, 506, 510, 514, respectively, used for generating a model (e.g., model 115 described by FIG. 1) used for monitoring emission indicators, in accordance with certain embodiments. In a non-limiting example, the one or more machine learning techniques includes pre-processing techniques, a deep neural network, post-processing techniques, or a combination thereof. The one or more machine learning techniques may implement a computer vision algorithm (e.g., a computer vision engine 114), for example. The computer vision algorithm segments a region of the image including the emission indicator using a model, for example.

In a non-limiting example, 32,400 images from 15 different flares at 5 different locations are used to build a deep learning model. The deep learning model may be a deep learning neural network, for example. The deep learning model may be a deep convolution neural network model, for example. The 32,400 images are frames of multiple videos capturing the 15 different flares, for example. The 32,400 images include images captured at different times of a day (e.g., dawn, daylight, dusk, evening, night), during different times of a year (e.g., winter, spring, summer, fall), and under different weather conditions (e.g., clear, cloudy, overcast, drizzly, stormy). The images are cropped so that each image includes a single flare captured at a consistent position and resized to a specified resolution (e.g., 256×256, 128×128, 512×512). The images may be cropped and resized as shown by images 500, 502, 506, 508, 512, for example. A flare tip width (e.g., width 306 described by FIG. 3) may range from 6 pixels to 24 pixels, 3 to 12 pixels, or 12 to 48 pixels, depending on the specified resolution, for example. The images may have a median flare tip width of 12 pixels, 8 pixels, or 30 pixels, depending on the specified resolution and following a log-normal distribution. A minimum height (e.g., height 310) of an ROI is at least twenty (20) times the flare tip width, and the height of the flare tip is approximately 10% of the minimum height of the ROI. In a non-limiting example, a configuration file of the model includes a specification, or settings, specifying the resolution, the flare tip width, the minimum height of the ROI, the height of the flare tip, or a combination thereof.

In a non-limiting example, 30,500 of the 32,400 images from 12 flares of the 15 flares are selected for training and validation with a 9:1 random split. Stratified splitting may be used to preserve the percentages of samples for emission events having high smoke, incipient smoke, and no smoke, which may be defined to have >2%, <2%, and 0 area coverage, respectively, for example. In another example, the percentages may be modified based on a specification. The other 1,900 of the 32,400 images from the remaining 3 flares of the 15 flares are used for validating the model. In a non-limiting example, the 1,900 images are manually labeled by visible emission professionals to calculate optimal thresholds for density and area parameters of a smoke region of an emission event. The training and validation images may be captured at 1-minute intervals, 1.5-minute intervals, 2.25-minute intervals, or other specified intervals.

In a non-limiting example, a first stage of the model, e.g., a segmentation stage, includes a deep convolutional and deconvolutional neural network to segment an emission event of an image into one or more regions. A genetic algorithm may be used to optimize hyperparameters, for example. Batch normalization between two adjacent convolution layers may be used to ensure robust learning. For 256×256 images, a base filter size of 64 may be used. In a non-limiting example, a filter size may be doubled as depth increases. Separable convolutional layers may be used to decrease compute time and model size in another non-limiting example. To avoid overfitting, two dropout layers with a dropout rate of 10% may be used after a fourth and fifth convolutional block.

In a non-limiting example, an output of the segmentation stage is a binary matrix having a size that is equivalent to a resolution of the input image. The binary matrix includes elements having a value of 1, which indicates a location of an emission indicator captured by the image. In a non-limiting example, a threshold of 60 may be used to remove small identified artifacts. For example, in response to determining a number of contiguous elements including emission indicators exceeds the threshold, the set of emission indicators is associated with an emission event.

In a non-limiting example, a second stage of the model, e.g., a detection stage, calculates one or more parameters (e.g., density, area, volume, period) of the emission event segmented during the first stage. For example, an area coverage is calculated by the total area of one or more smoke regions of the emission event divided by a total area of the image in pixels. A smoke density is calculated by one minus a normalized projection of the average RGB vector of the one or more smoke regions to that of the surrounding background. To ensure a sufficient samples of pixels from surrounding background without including a flame of the emission event, background that is within 8 pixels of the one or more smoke regions is considered. In a non-limiting example, the number of background pixels may be increased or decreased based on a resolution of the image. If one of the one or more parameters exceeds a respective threshold, the image is classified as including a smoke event.

In a non-limiting example, a performance of the model may be evaluated against human decision from the aforementioned external testing flare dataset. The model is trained with 27,450 images and validated with 3,050 images. The first stage, segmentation, classifies smoke at the pixel level. In the segmentation stage, the model achieves a training accuracy of 0.99, a validation accuracy of 0.96, and an external testing accuracy of 0.95. The second stage, detection, detects whether there is smoke present in the image. Smoke labels at the image level are obtained from 5 visible emission professionals with each image labeled twice by individuals on different days. A majority vote of human observations may be used as the true label for performance benchmarking. Human error is defined by a sum of two types of errors, inconsistent decisions between two observations and between different labelers. The image samples including human errors includes 3.2% of the external testing dataset. As a result, an average error rate for human observations is 1.6% with a 50% chance to make a correct decision through a random guess. The average error rate of the model is 0.2%, which is 1/8 of the average error rate for human observations.

The model performance may then be evaluated against visible emission standards. The standards are short videos of smoke at different opacity levels ranging from 0% to 95% to train emission control operators to identify smoke events. Accurate characterization of low smoke levels (opacity <15%) requires significant operator time and attention. In contrast, the model accurately captures the smoke region for each standard, as shown by a segment 504 of the image 502, a segment 508 of the image 506, a segment 512 of the image 510, and segments 516, 518 of the image 514, where the segments are identified using the model.

In another non-limiting example, the model performance may be evaluated against the visible emission standards by graphing a density parameter versus an opacity parameter. FIG. 6 is a plot 600 illustrating a correlation between density and opacity parameters, in accordance with certain embodiments. The correlation is robust, as shown by the plot 600, which is a mean-standard deviation plot. The plot 600 shows a low standard deviation of each calculated density across 20 images for each standard. At low opacities, the density parameter increases linearly with increased opacity.

The model is designed to detect visible emission. Vision requires adequate light on an object of interest and travelling path of light from the object of interest. Missing either of the prerequisites may reduce a visibility of the object of interest. Excessive light may cause optical defect or excessive light ratio that exceeds a dynamic range of an image sensor (e.g., the image sensor 104 described in FIG. 1). Insufficient light may cause severe fog in an image due to clogging of a traveling path of light. For low light conditions, a smoke region may be misidentified as background, for example. In another example, for low visibility conditions with severe smog, the smog may be misidentified as smoke. When determining placement of image sensors for capturing images of flare stacks, both a brightness index and a sharpness index may be considered. The brightness index is defined as the average brightness of all pixels in the image frame. The sharpness index is defined as the binary logarithm variance of Laplacian of the image frame.

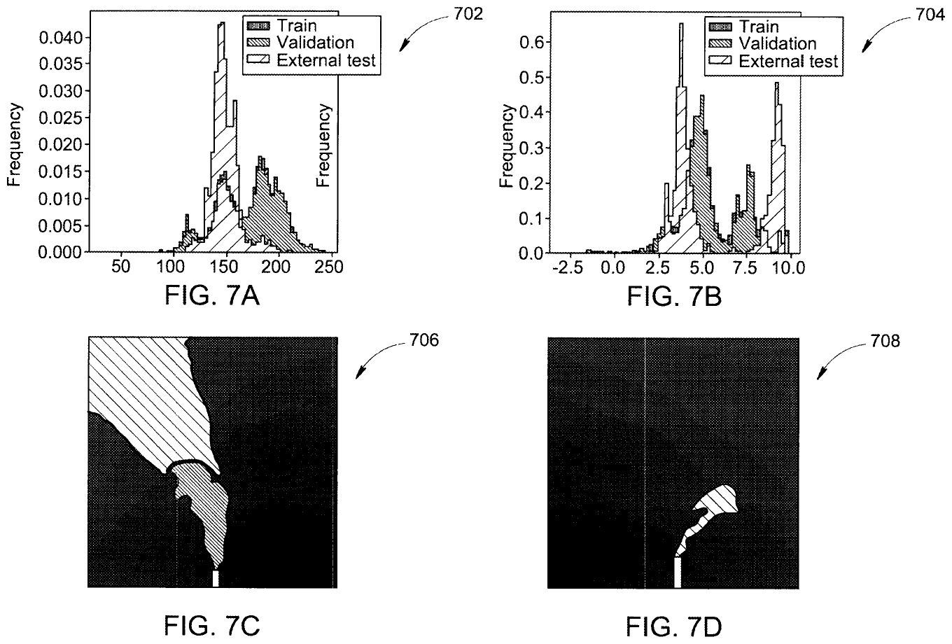

FIGS. 7A-7B are plots 702, 704 illustrating a brightness index and a sharpness index, respectively, of the datasets used to train the one or more models used for monitoring emission indicators, in accordance with certain embodiments. The plot 702 shows that a model may become less accurate (e.g., dice index less than 0.3) when a processed image has a brightness index below 70. An image 706 having a brightness index 70 is shown in FIG. 7C, for example. The plot 704 shows that a model may become less accurate when the processed image has a sharpness index below 1. An image 708 having a sharpness index 1 is shown in FIG. 7D, for example.

In a non-limiting example, the plots 702, 704 may be used to modify a placement of image sensors for capturing images of flare stacks, a placement of one or more light sources, a frame rate for the image sensors, or a combination thereof. For example, a distance between an image sensor and a flare stack may be modified to improve visibility. In another example, the plots 702, 704 may be used to determine a placement of a second image sensor having a different field of view of the flare stack. The different field of view may be attributable to the second image sensor having a different distance (e.g., less than, greater than) to the flare stack, a different angle (e.g., less acute, more acute, less obtuse, more obtuse), or a combination thereof, than the distance, angle, or combination thereof, between the first image sensor and the flare stack. In another example, the plots 702, 704 may be used to determine a placement (e.g., distance, angle) of a light source with respect to the first image sensor, the second image sensor, the flare stack, or a combination thereof. In another example, the plots 702, 704 may be used to modify frame rates of the image sensors. For example, to decrease an amount of light intake of the first image sensor, the frame rate of the first image sensor may be increased, and to increase an amount of light intake of the second image sensor, the frame rate of the second image sensor may be decreased.

Using the systems and methods described herein, an amount of time to recognize emission events are reduced when compared to human observation times, and an accuracy in recognizing the emission events is increased when compared to human observation times, as shown by Table 1.

TABLE 1
Speed and Error Rates for Recognizing Emission events

| | Speed | | Averaged Error Rate |
|---|---|---|---|
| Human Observations | 10 | sec/frame | 1.6% |
| System Observations | 0.3-2.5 | sec/frame | 0.2% |

### Further Embodiments

While the image sensor 104, the network interface 110, the processor 108, and the computer-readable medium 112 are shown as distinct components, one or more of the image sensor 104, the network interface 110, the processor 108, or the computer-readable medium 112 may be integrated within a single electronic device. For example, the image sensor 104, the network interface 110, the processor 108, and the computer-readable medium 112 may be components of an Internet Protocol (IP) camera, or other digital camera. In another example, the image sensor 104 is an image sensor 104 of an analog camera communicatively coupled via the network interface 110 to an IP encoder, or other digital encoder, where the IP encoder includes the processor 108 and the computer-readable medium 112, and where the processor 108 converts analog input data (e.g., data received from the image sensor 104 of the analog camera) to a digital output that is the image. In another example, the image sensor 104 is an image sensor 104 of an analog camera communicatively coupled via the network interface 110 to an edge device (e.g., router, routing switch, integrated access device, multiplexer) that controls a flow of data between multiple networks, where the edge device includes the processor 108 and the computer-readable medium 112. Deploying the computer vision engine 114 and the server engine 116 within the IP camera or the IP encoder improves data security by limiting information transmitted via a network (e.g., the images are used and processed at the point of capture). Limiting information transmitted also reduces bandwidth usage of the network. In yet another non-limiting example, the image sensor 104 is communicatively coupled via the network interface 110 to a computer system. The computer system includes the processor 108 and the computer-readable medium 112. In a non-limiting example, the computer system is an electronic device that includes the computer-readable medium 112 having at least 128 megabytes (MB) of storage, a system memory of at least 512 MB, and an operating system (e.g., LINUX, WINDOWS, or the like). Deploying the computer vision engine 114 and the server engine 116 within a computer system sharing a same network as the image sensor 104 improves data security by limiting information transmitted between multiple networks (e.g., the images are used and processed within the facility housing the flare stack 102). Limiting information transmitted also reduces bandwidth usage between the multiple networks.

In a non-limiting example, the system 100 includes one or more computer systems (e.g., a computer system associated with the processor 108, a computer system associated with the processor 120) that communicate via a combination of local or remote networks via one or more network interfaces (e.g., the network interface 110), such as in a distributed system that is hosted, completely, or in part, in the cloud. A computer system may include one or more processors, one or more computer-readable mediums communicatively coupled to the one or more processors, and machine-readable instructions stored to the one or more computer-readable mediums. Processors of the one or more processors may include a microcontroller, a microprocessor, an embedded processor, a digital signal processor, an image signal processor, a dual processor, a multi-core processor, a field-programmable gate array (FPGA), a quantum processor, an advanced reduced instruction set computer (RISC) machine (ARM), or the like. A processor may be referred to as a central processing unit (CPU), a graphical processing unit (GPU), a neural processing unit (NPU), a vision processing unit (VPU), or the like. When executed by the one or more processors, the machine-readable instructions cause the one or more processor to perform the methods described herein. The one or more processors, the one or more computer-readable mediums, or a combination thereof, may be housed within a single computer system or within multiple computer systems. The multiple computer systems may be located within a single location or located remotely from one another. For example, one or more of the one or more processors, one or more computer-readable mediums, or a combination thereof, may be a remote system hosted, completely, or in part, in the cloud. The multiple computer systems may be in communication via one or more logical connections, such as a local area network (LAN), a wide area network (WAN), or a combination thereof. One or more network interfaces may enable communication between the multiple computer systems. The one or more network interfaces may include network adapters, routers, modems, or a combination thereof, for example.

While systems and methods are described herein in terms of “comprising” various components or steps, the systems and methods can also “consist essentially of” or “consist of” the various components and steps. One or more illustrative incarnations incorporating one or more invention elements are presented herein. Not all features of a physical implementation are described or shown in this application for the sake of clarity. It is understood that in the development of a physical embodiment incorporating one or more elements of the present systems, devices, or methods disclosed, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

The methods associated with monitoring emission indicators described herein are, at least in part, performed using computing devices or processor-based devices that include at least one processor and at least one computer-readable medium storing machine-readable instructions and communicatively coupled to the processor. When executed by the processor, the machine-readable instructions cause the processor to perform the methods described herein. The computing devices or processor-based devices may herein be referred to generally by the shorthand “computer” or “computer system.” Any calculation, determination, or analysis recited as part of methods described herein may be carried out in whole or in part using a computer system, described herein.

Furthermore, the machine-readable instructions of such computers may be a portion of code, or software, stored to a non-transitory computer-readable medium. Any suitable processor-based device may be utilized for implementing all or a portion of embodiments of the present techniques, including without limitation personal computers, networks, laptop computers, computer workstations, mobile devices, multi-processor servers or workstations with (or without) shared memory, high performance computers, and the like. Moreover, embodiments may be implemented on application-specific integrated circuits (ASICs) or very large scale integrated (VLSI) circuits.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, an EPROM, a EEPROM, a FLASH-EPROM, a flash memory, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

Installation of the machine-readable instructions for performing the methods described herein may be performed in accordance with techniques known by one skilled in the art. The machine-readable instructions may be compiled as an executable file for a computer application, for example. The computer application may be installed to a computer-readable medium. The computer-readable medium may be a memory device of an IP camera, an IP encoder, a mobile device, a computer, or other processor-based device, for example. In a non-limiting example, the computer application may be installed via a web portal. In another non-limiting example, an authorized user of the processor-based device may access the processor-based device remotely and install the machine-readable instructions. Installing the computer application may include selecting a configuration file based on a type of image sensor, processor-based device, or combination thereof. The configuration file may include settings for a model used by the computer application for monitoring emission indicators, where the settings are based on the type of image sensor, the processor-based device, or a combination thereof.

### Additional Embodiments

Embodiment 1: An electronic device comprising: a processor; a non-transitory computer-readable medium storing machine-readable instructions, which, when executed by the processor, cause the processor to: identify, using a computer vision model, an emission indicator captured by an image; determine, using the computer vision model, one or more parameters of the emission indicator; and generate an indication indicating whether the emission indicator is representative of a emission event based on the one or more parameters.

Embodiment 2: The electronic device of Embodiment 1, wherein the non-transitory computer-readable medium is to store a server engine configured to enable communication between the electronic device and a control system of a flare stack, and wherein the processor is operable to transmit, via the server engine, the indication to the control system.

Embodiment 3: The electronic device of Embodiments 1-2, wherein the processor is operable to: receive, via the server engine, one or more settings; and update a model setting, one or more thresholds, or a combination thereof based on the one or more settings.

Embodiment 4: The electronic device of Embodiments 1-3, wherein the processor is operable to determine that the emission indicator is representative of the emission event in response to at least one of the one or more parameters exceeding an associated threshold of the one or more thresholds.

Embodiment 5: The electronic device of Embodiments 1-4, wherein the processor is operable to: determine an instruction in response to the emission indicator being representative of the emission event, wherein the instruction is based on the one or more parameters; and transmit, via the server engine, the instruction.

Embodiment 6: The electronic device of Embodiments 1-5, wherein the image is a first image associated with a first time stamp, and wherein the processor is operable to: identify, using the computer vision model, the emission indicator in a second image associated with a second time stamp; calculate a period of the emission event based on the first and the second time stamps; and transmit, via the server engine, the period of the emission event to the control system.

Embodiment 7: The electronic device of Embodiments 1-6, wherein the processor is operable to: determine an amount of smoke caused by the emission event based on the period of the emission event and at least one of the one or more parameters; and transmit, via the server engine, the amount of smoke caused by the emission event to the control system.

Embodiment 8: The electronic device of Embodiment 1-7, wherein the processor is operable to generate a first stage of the computer vision model to segment the image using a deep convolution and deconvolutional neural network, a genetic algorithm, batch normalization, filtering, and dropout layers trained using a training set of data.

Embodiment 9: The electronic device of Embodiments 1-8, wherein an output of the first stage is a binary matrix.

Embodiment 10: The electronic device of Embodiments 1-9, wherein the processor is operable to generate a second stage of the computer vision model to determine the one or more parameters of the emission event based on the binary matrix.

Embodiment 11: A method comprising: identifying, using a computer vision model, an emission indicator captured by an image; determining, using the computer vision model, one or more parameters of the emission indicator; and generating an indication indicating whether the emission indicator is representative of a emission event based on the one or more parameters.

Embodiment 12: The method of Embodiment 11, wherein the computer vision model uses a deep learning neural network.

Embodiment 13: The method of Embodiments 11-12, wherein the one or more parameters include a density of smoke caused by the emission event, an area of the emission event, or a combination thereof.

Embodiment 14: The method of Embodiments 11-13, comprising one of: determining, in response to at least one of the one or more parameters exceeding an associated threshold of one or more thresholds, that the emission indicator is representative of the emission event; and determining, in response to the at least one of the one or more parameters being less than or equivalent to the associated threshold of the one or more thresholds, that the emission indicator is representative of another event.

Embodiment 15: The method of Embodiments 11-14, comprising generating an instruction in response to the indication indicating that the emission indicator is representative of the emission event, wherein the instruction is based on the at least one of the one or more parameters.

Embodiment 16: The method of Embodiments 11-15, wherein the image is a first image associated with a first time stamp, and comprising: identifying, using the computer vision model, the emission indicator in a second image associated with a second time stamp; determining a period of the emission event based on the first and the second time stamps, and wherein a notification includes the period of the emission event.

Embodiment 17: The method of Embodiments 11-16, comprising: determining an amount of smoke caused by the emission event based on the period of the emission event and the at least one of the one or more parameters, and wherein the instruction includes the amount of smoke caused by the emission event.

Embodiment 18: A system, comprising: an image sensor to capture an image of a flare stack; one or more non-transitory, computer-readable mediums storing a computer vision engine configured to determine whether an emission indicator captured by the image indicates an emission event; and a server engine configured to transmit a notification indicating whether the emission indicator indicates the emission event to a control system of the flare stack.

Embodiment 19: The system of Embodiment 18, wherein the server engine is configured to receive one or more settings from the control system, and wherein the computer vision engine is configured to update one or more model settings, one or more thresholds, or a combination thereof, based on the one or more settings.

Embodiment 20: The system of Embodiments 18-19, wherein the computer vision engine is configured to: identify, using a deep convolutional neural network (DCNN) model, the emission indicator captured by the image; determine, using the DCNN model, one or more parameters of the emission indicator; determine that the emission indicator indicates the emission event in response to at least one of the one or more parameters exceeding an associated threshold of the one or more thresholds; and determine that the emission indicator indicates another event in response to the at least one of the one or more parameters of the emission indicator being less than or equivalent to the associated setting of the one or more thresholds.

Therefore, the present systems and methods disclosed are well adapted to attain the ends and advantages mentioned as well as those that are inherent therein. The particular examples and configurations disclosed above are illustrative only, as the present systems and methods disclosed may be modified and practiced in different but equivalent manners apparent to those skilled in the art having the benefit of the teachings herein. Furthermore, no limitations are intended to the details of construction or design herein shown, other than described in the claims below. It is therefore evident that the particular illustrative examples disclosed above may be altered, combined, or modified and all such variations are considered within the scope and spirit of the present systems and methods disclosed. The systems, devices, and methods illustratively disclosed herein suitably may be practiced in the absence of any element that is not specifically disclosed herein and/or any optional element disclosed herein.

All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Unless otherwise indicated, all numbers expressing tolerances, ranges, and so forth used in the present specification and associated claims are to be understood as being modified in all instances by the term “about” and take into account experimental error and variations that would be expected by a person have ordinary skill in the art. Accordingly, unless indicated to the contrary, the numerical parameters set forth in the following specification and attached claims are approximations that may vary depending upon the desired properties sought to be obtained by the incarnations of the present systems and methods disclosed. At the very least, and not as an attempt to limit the application of the doctrine of equivalents to the scope of the claim, each numerical parameter should at least be construed in light of the number of reported significant digits and by applying ordinary rounding techniques. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. An electronic device comprising:
a processor;
a non-transitory computer-readable medium storing machine-readable instructions, which, when executed by the processor, cause the processor to:
identify, using a computer vision model, an emission indicator captured by an image;
determine, using the computer vision model, one or more parameters of the emission indicator; and
generate an indication indicating whether the emission indicator is representative of a emission event based on the one or more parameters.

2. The electronic device of claim 1, wherein the non-transitory computer-readable medium is to store a server engine configured to enable communication between the electronic device and a control system of a flare stack, and wherein the processor is operable to transmit, via the server engine, the indication to the control system.

3. The electronic device of claim 2, wherein the processor is operable to:
receive, via the server engine, one or more settings; and
update a model setting, one or more thresholds, or a combination thereof based on the one or more settings.

4. The electronic device of claim 3, wherein the processor is operable to determine that the emission indicator is representative of the emission event in response to at least one of the one or more parameters exceeding an associated threshold of the one or more thresholds.

5. The electronic device of claim 4, wherein the processor is operable to:
determine an instruction in response to the emission indicator being representative of the emission event, wherein the instruction is based on the one or more parameters; and
transmit, via the server engine, the instruction.

6. The electronic device of claim 2, wherein the image is a first image associated with a first time stamp, and wherein the processor is operable to:
identify, using the computer vision model, the emission indicator in a second image associated with a second time stamp;
calculate a period of the emission event based on the first and the second time stamps; and
transmit, via the server engine, the period of the emission event to the control system.

7. The electronic device of claim 6, wherein the processor is operable to:
determine an amount of smoke caused by the emission event based on the period of the emission event and at least one of the one or more parameters; and
transmit, via the server engine, the amount of smoke caused by the emission event to the control system.

8. The electronic device of claim 1, wherein the processor is operable to generate a first stage of the computer vision model to segment the image using a deep convolution and deconvolutional neural network, a genetic algorithm, batch normalization, filtering, and dropout layers trained using a training set of data.

9. The electronic device of claim 8, wherein an output of the first stage is a binary matrix.

10. The electronic device of claim 9, wherein the processor is operable to generate a second stage of the computer vision model to determine the one or more parameters of the emission event based on the binary matrix.

11. A method, comprising:
identifying, using a computer vision model, an emission indicator captured by an image;
determining, using the computer vision model, one or more parameters of the emission indicator; and
generating an indication indicating whether the emission indicator is representative of a emission event based on the one or more parameters.

12. The method of claim 11, wherein the computer vision model uses a deep learning neural network.

13. The method of claim 12, wherein the one or more parameters include a density of smoke caused by the emission event, an area of the emission event, or a combination thereof.

14. The method of claim 13, comprising one of:
determining, in response to at least one of the one or more parameters exceeding an associated threshold of one or more thresholds, that the emission indicator is representative of the emission event; and
determining, in response to the at least one of the one or more parameters being less than or equivalent to the associated threshold of the one or more thresholds, that the emission indicator is representative of another event.

15. The method of claim 14, comprising generating an instruction in response to the indication indicating that the emission indicator is representative of the emission event, wherein the instruction is based on the at least one of the one or more parameters.

16. The method of claim 15, wherein the image is a first image associated with a first time stamp, and comprising:
identifying, using the computer vision model, the emission indicator in a second image associated with a second time stamp;
determining a period of the emission event based on the first and the second time stamps, and
wherein a notification includes the period of the emission event.

17. The method of claim 16, comprising:
determining an amount of smoke caused by the emission event based on the period of the emission event and the at least one of the one or more parameters, and
wherein the instruction includes the amount of smoke caused by the emission event.

18. A system, comprising:
an image sensor to capture an image of a flare stack;
one or more non-transitory, computer-readable mediums storing a computer vision engine configured to determine whether an emission indicator captured by the image indicates an emission event; and
a server engine configured to transmit a notification indicating whether the emission indicator indicates the emission event to a control system of the flare stack.

19. The system of claim 18, wherein the server engine is configured to receive one or more settings from the control system, and wherein the computer vision engine is configured to update one or more model settings, one or more thresholds, or a combination thereof, based on the one or more settings.

20. The system of claim 19, wherein the computer vision engine is configured to:
identify, using a deep convolutional neural network (DCNN) model, the emission indicator captured by the image;
determine, using the DCNN model, one or more parameters of the emission indicator;
determine that the emission indicator indicates the emission event in response to at least one of the one or more parameters exceeding an associated threshold of the one or more thresholds; and
determine that the emission indicator indicates another event in response to the at least one of the one or more parameters of the emission indicator being less than or equivalent to the associated setting of the one or more thresholds.
